(19) United States
(12) Patent Application Publication
(10) Pub. No.: US 2006/0014118 A1
(43) Pub. Date: Jan. 19, 2006

(54) Dental hygiene accessory

(76) Inventor: John J. Utama, Isle of Capri (AU)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/146,784

(22) Filed: Jun. 7, 2005

(30) Foreign Application Priority Data
Jun. 8, 2004 (AU) 2004903080

(51) Int. Cl. A61C 3/00

(52) U.S. Cl. 433/31; 433/29

(57) ABSTRACT

A dental hygiene accessory comprises a torch having a housing. A mirror is attached to the torch. A dispenser that holds a liquid plaque discloser is removably attached to the torch. In use, the dispenser is moved inwardly relative to the torch to dispense 3 or 4 drops of the plaque dispenser onto the tongue of a user. The torch may then be turned around so that the dental mirror is positioned into the mouth. The illuminated dental mirror will let users identify the hard-to-see areas of the teeth particularly the inside surfaces of the teeth, where plaque can be detected and removed.

### FIELD OF THE INVENTION

The present invention relates to an accessory that can be used to facilitate or improve dental hygiene. The accessory may be used by dentists or it may be used in the home environment.

### BACKGROUND TO THE INVENTION

Plaque is a sticky, colourless film of bacteria that accumulates on the teeth. Bacteria and their by-products are the major factors in causing dental decay and periodontal disease. Dental decay requires fillings and can lead to infection and ultimately, tooth loss, if untreated. Studies have also shown that periodontal disease may be a potential risk factor for other health problems. Periodontal disease may increase the risk of such diseases as heart disease, diabetes and respiratory tract diseases.

Dentists are still struggling to control plaque. Technology such as implants, crowns and bridges make it possible for people to have their broken down or missing teeth restored in a fashion that is close to their original structure and function. However, it is preferable to promote sound dental hygiene in order to prevent or avoid dental deterioration, rather than try to repair the damage caused by dental deterioration.

Traditionally, plaque is removed by the use of toothbrushes, dental floss and/or mouth rinses. However, one of the reasons why plaque is left behind on the teeth after brushing is due to the similarity in colour between the teeth and the plaque. In effect, the plaque is camouflaged on the tooth surface. When a person brushes his or her teeth, plaque may not be removed completely. Due to the colour of the plaque, it is difficult to see that all the plaque has been removed. This can lead to some plaque on the teeth, even after brushing. In time, this can lead to the destruction of the tooth tissue and periodontal structures.

As soon as teeth erupt in the oral cavity, they are immediately under attack from the acid produced by the bacteria in plaque. The Stephan curve, as shown in FIG. 1, describes the change in dental plaque pH in response to some element of the diet. In the examples shown in FIG. 1, dental plaque was challenged with a fermentable carbohydrate by asking a volunteer to rinse with 10 ml of 10% sucrose solution for 10 seconds. Average plaque samples were removed at intervals and a pH recorded. Characteristically, the Stephan curve reveals a rapid drop in plaque pH, followed by a slower rise until the resting pH is obtained. The time course varies between individuals and the nature of the challenge. When the pH falls below the critical level at 5.5, demineralisation of the tooth enamel occurs. This leads to decay and cavitation in the tooth.

To minimise the destructive effects of plaque on the oral tissues, toothbrushes and floss are used to remove the plaque. With greater awareness in oral health education, there has been a gradual improvement in the prevention of tooth decay and gum disease. However, the problem does still exist.

The effectiveness of tooth brushing is greatly enhanced by the introduction of a plaque discloser. The plaque discloser highlights the plaque on tooth surfaces so that users can actually see what they are removing. Plaque disclosers have mainly been used by patients on the recommendation of their dentists. They come in two forms:

a) Tablet discloser wherein the patient chews the tablet for a short period of time. The discloser highlights the plaque and the patient subsequently removes the plaque with a toothbrush and/or dental floss; and

b) Liquid disclosers, which have mainly been used in the dentist's surgery or as an instructional tool.

Paste disclosers, having a consistency similar to toothpaste, may also be used.

FIG. 2 shows a diagram of a mouth after use of a plaque discloser. The plaque discloser highlights the plaque on tooth surfaces so users can actually see the presence of the plaque.

Although plaque disclosers clearly show the presence of plaque on the front surfaces of teeth, a person will have difficulty revealing the plaque that is on the rear surface of the teeth (i.e. on the surface of the teeth facing inside the mouth).

There exists a need for a convenient device that will facilitate the use of plaque disclosers.

A number of dentists use caries detector solution to detect the presence of dental caries. In one use of such caries detector solutions, a dentist may prepare a tooth having a cavity for filling by removing the decay and, prior to filling the prepared tooth with composite or amalgam, use the caries detector solution to check that all of the decay has been removed from the tooth. The caries detector solution works in a similar manner to plaque discloser in that the caries detector solution is applied to the mouth and areas of caries are highlighted.

### BRIEF DESCRIPTION OF THE INVENTION

In a first aspect, the present invention provides a dental hygiene accessory comprising a housing, a mirror attached to the housing and a dispenser for dispensing a plaque discloser or a caries detector solution, the dispenser being attached to the housing.

Preferably, the dental hygiene accessory further includes a light source for illuminating the mirror.

Preferably, the mirror is removably attached to the housing.

Preferably, the dispenser is removably attached to the housing.

In a preferred embodiment, the light source is contained within the housing. The dental hygiene accessory may suitably incorporate a torch, which torch includes the housing and the light source. The light source is preferably located at one end of the torch. The mirror may be adapted to be removably attached to the torch at or near the end where the light source is located.

The mirror may include mounting means for mounting the mirror to the housing. The mounting means may comprise one or more clips that engage with an outer surface of the housing. Alternatively, the mounting means may comprise a sleeve that fits over the housing and is retained on the housing. The sleeve is suitably open at both ends to allow light transmission therethrough so that light from the light source can impinge on the mirror to thereby illuminate the mirror. It will also be appreciated that one end of the sleeve may be a closed end if that closed end incorporates or consists of a transparent window.

The mirror is preferably arranged so that it extends at an angle to a longitudinal axis of the housing. In this manner, viewing of the inside surfaces of the teeth is facilitated.

The dispenser is preferably removably attached to the housing. The dispenser may include mounting means for mounting the dispenser to the housing. The mounting means may comprise one or more clips. More preferably, the mounting means comprises an opening in a wall of the dispenser, said opening being arranged to receive an end of the housing such that the dispenser becomes removably attached to the housing. Preferably, the opening in a wall of the dispenser comprises an opening in an end wall of the dispenser.

The accessory is most preferably configured such that the mirror is attached to one end of the housing and the dispenser is attached to an opposite end of the housing.

In a preferred embodiment, the dispenser includes a chamber for holding the plaque discloser or the caries detector solution, the chamber having an outlet through which the plaque discloser or the caries detector solution may be dispensed, and the dispenser being operable to dispense plaque discloser or caries detector solution through the outlet. More preferably, the dispenser includes the chamber having an outlet for the plaque discloser or caries detector solution and a moveable wall, the moveable wall being moved by relative inward motion between the dispenser and the housing to thereby reduce the volume of the chamber and force plaque discloser or caries detector solution through the outlet. More preferably, the dispenser is slideably mounted to the housing and movement of the dispenser inwardly relative to the housing causes an end of the housing to contact the moveable wall to thereby reduce the volume of the chamber and dispense plaque discloser or caries detector solution through the outlet.

The moveable wall may comprise a stopper, such as a rubber stopper. The moveable wall preferably prevents leakage of plaque discloser around the moveable wall in instances where the chamber contains liquid plaque discloser.

In another embodiment, the chamber may include a flexible or pliable wall to allow the chamber to be squeezed to dispense the plaque discloser.

When the chamber contains a liquid plaque discloser or caries detector solution, the outlet of the chamber is suitably arranged such that the plaque discloser or caries detector solution can pass therethrough when the dispenser is being used, but the plaque discloser does not leak therefrom when not in use. The outlet may include a self-closing valve, such as a flap valve or a tri-cut valve, or it may comprise a restricted diameter orifice. Other suitable arrangements for the outlet may also be used.

The dispenser may include gripping means for gripping by the user to facilitate use of the dispenser and dispensing of the plaque discloser. The gripping means may comprise an upstanding ridge or flange extending from an outer surface of the dispenser.

The housing is preferably a generally cylindrical housing. As mentioned above, the housing may comprise part of a torch. The torch preferably includes an on/off switch. The torch is suitably powered by batteries.

The housing may include a plurality of projections at or near one end thereof, which projections cooperate with the dispenser to deliver a predetermined amount of the plaque discloser or caries detector solution. For example, the dispenser may contact the projections in a manner such that movement of the dispenser inwardly relative to the housing causes the dispenser to ride up over and along one projection until the dispenser (or a part thereof) nestles in a trough between the two projections. In this way, the dispenser is advanced by a distance equivalent to the space between two adjacent troughs between a projection. Thus, the dispenser can be operated by the user to move one projection at a time, thereby dispensing a predetermined amount of the plaque discloser or caries detector solution.

The plaque discloser used in the present invention is suitably a liquid plaque discloser or a paste plaque discloser. Such plaque disclosers will be readily known to persons skilled in the art. Tablet plaque disclosers may also be used.

In a second aspect, the present invention provides a kit for assembling to form the dental hygiene accessory of the first aspect of the present invention, the kit including a torch, a mirror adapted to be removably mounted to the torch and a dispenser for dispensing a plaque discloser or caries detector solution, the dispenser including mounting means for removably attaching the dispenser to the torch.

Preferred features of the parts of the kit of the second aspect of the invention are as described with reference to the first aspect of the present invention.

The dispenser containing the plaque discloser will eventually run out of plaque discloser or caries detector solution following repeated use. It is an advantage of preferred embodiments of the present invention that the dispenser can be removed from the housing and replaced with a fresh dispenser. Accordingly, in a third aspect, the present invention provides a dispenser for use with a dental hygiene accessory as described in the first aspect of the invention, the dispenser including a chamber for holding a plaque discloser or caries detector solution, an outlet through which the plaque discloser or caries detector solution is dispensed, and mounting means for removably attaching the dispenser to the housing. The dispenser can be operated to dispense plaque discloser or caries detector solution from the outlet of the chamber.

The mirror may also comprise a replacement part for the dental hygiene accessory. Thus, in a fourth aspect, the present invention provides a mirror for use with the dental hygiene accessory of the first aspect of the present invention, the mirror including mounting means for removably attaching the mirror to the housing.

In a further aspect, the present invention provides a dental accessory comprising a dispenser containing a plaque discloser or caries detector solution, the dispenser being attached to a housing, the housing having a curve at or near one end thereof and an illumination source for providing light to the one end. The dispenser may be removably attached to the housing. The dispenser is suitably attached to the end of the housing opposite to the one end. In this aspect of the present invention, the curve in the housing allows light to be directed to a site within the mouth whilst allowing good visibility to the site.

In yet a further aspect, the mirror used in the first aspect of the invention may be replaced with a member for transmitting light, the member including a curve at or near one end thereof. The member may be attached to the housing of the first aspect of the present invention.

### BRIEF DESCRIPTION OF THE DRAWINGS

FIG. 1 shows the Stephan curve, which is a graph of dental plaque pH against time;

FIG. 2 is a diagram of the teeth following application of a plaque discloser thereto;

FIG. 3 is a schematic diagram of a torch for use in the present invention;

FIG. 4 shows a schematic diagram of a mirror in accordance with the fourth aspect of the present invention and for use in other aspects of the present invention;

FIG. 5 is a schematic diagram of a dispenser for dispensing plaque discloser in accordance with the third aspect of the present invention and for use in other aspects of the present invention;

FIG. 6 shows a schematic diagram of a dental hygiene accessory in accordance with the present invention;

FIG. 7 shows a schematic diagram of a dispenser for dispensing plaque discloser in tablet form;

FIG. 8 shows a schematic view of an end of the torch arranged to interact with the dispenser to deliver a measured dose of plaque discloser;

FIG. 9 shows a side view of an embodiment of another aspect of the present invention;

FIG. 10 shows an end view of one form of valve that may be used in the dispenser used in the present invention; and

FIG. 11 shows an end view of another from of valve that may be used in the dispenser used in the present invention.

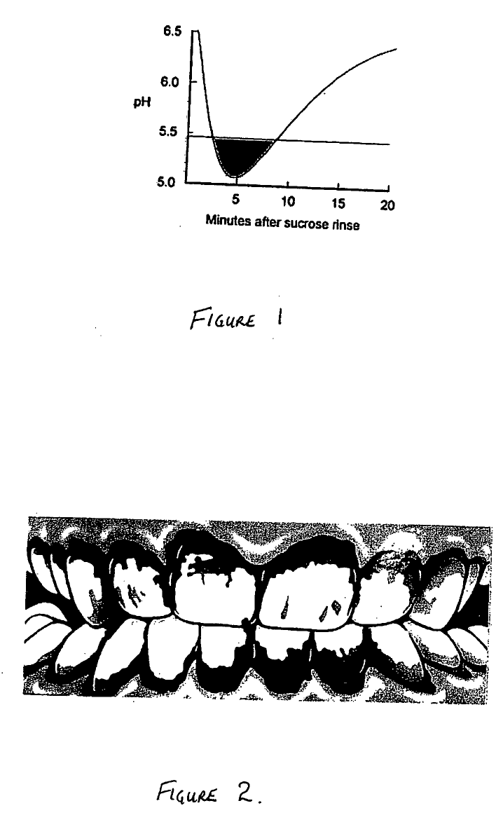

### DETAILED DESCRIPTION OF THE DRAWINGS

The attached drawings show preferred embodiments of the present invention. It will be understood that the drawings have been provided for the purposes for illustrating preferred embodiments of the present invention and that the invention should not be considered to be limited to the features shown therein.

For convenience, FIGS. 3 to 8 are described with reference to use for dispensing a plaque discloser. However, it will be appreciated that the embodiments shown in FIGS. 3 to 8 may also be used to dispense a caries detector solution.

FIG. 3 shows a torch 10 that can be used in the dental hygiene apparatus of the present invention. Torch 10 includes a housing 12. The housing 12 is of generally elongate cylindrical configuration. A light source 14 is located at one end of the torch 10. An on/off switch 16 is provided to control operation of the light in the torch.

The housing 12 of torch 10 is suitably a elongate, generally cylindrical housing. The housing 12 may hold one or more batteries for powering the light source 14. Although not shown, the housing 12 may include a removable closure for allowing access to the batteries for replacement.

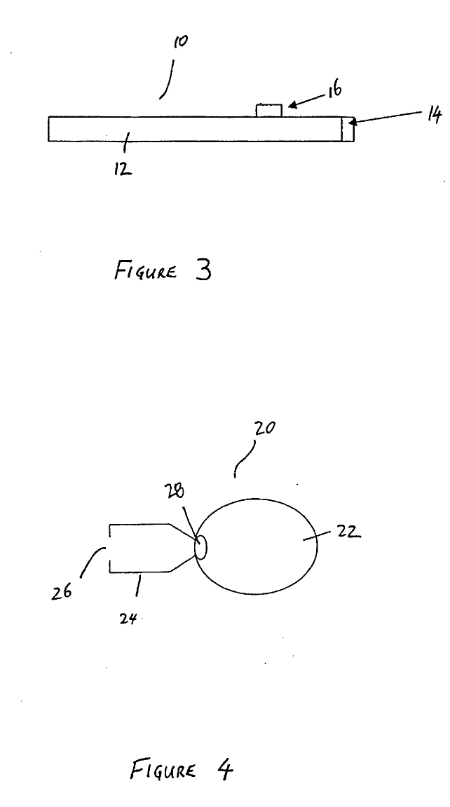

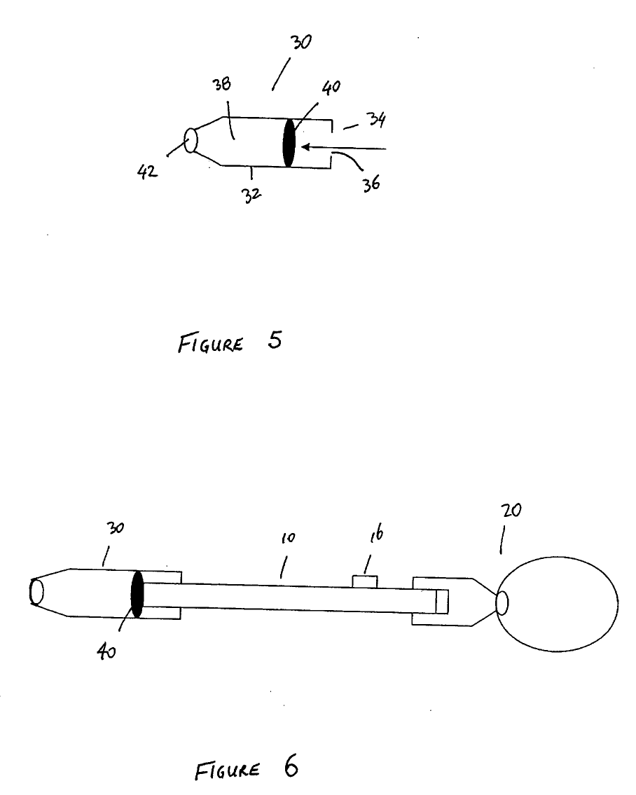

FIG. 4 shows a mirror 20 that can be used in the present invention. Mirror 20 includes a mirror surface 22 that is attached to or formed with a mounting means 24. Mounting means 24 is in the form of a sleeve having an opening 26 at one end. The sleeve has an opening 28 at its other end. The sleeve has a hollow sleeve such that light can be transmitted through the sleeve to eliminate the mirror surface 22. The mirror is suitably arranged such that mirror surface 22 extends at an angle, such as 30°, to the torch when attached to the torch.

FIG. 5 shows a dispenser 30 for use in the dental hygienic accessory of the present invention. The dispenser 30 comprises a dispenser housing 32. One end 34 of dispenser housing 32 includes an opening 36. The opening 36 is sized such that it can slideably receive an end of the torch 10. In this fashion, the dispenser 30 can be removably attached to the torch 10.

The dispenser housing 32 defines a chamber 38. In the embodiment of FIG. 5, the chamber 38 holds a liquid plaque dispenser. Rubber stopper 40 bounds one end of chamber 38. The rubber stopper 40 is a movable stopper that forms a movable wall of the chamber.

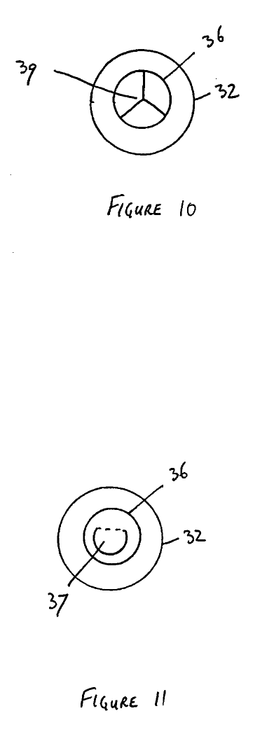

The chamber 38 also includes an outlet 42. Outlet 42 allows a plaque discloser that is contained in chamber 38 to be dispensed from the chamber. The outlet 42 is preferably arranged such that a liquid plaque dispenser cannot leak from the outlet but, when pressure is applied to the plaque dispenser in the chamber 38, the plaque dispenser is dispensed through the outlet 42. In this regard, the outlet 42 may incorporate a flap valve (see 37 in FIG. 11), a tri-cut silicone valve (see 39 in FIG. 10), or it may comprise a small diameter opening.

FIG. 6 shows the dental hygiene apparatus of the present invention in its assembled state. In order to assemble the dental hygiene apparatus shown in FIG. 6, the mirror 20 is mounted over the end of torch 10 that carries light source 14. This is achieved by inserting the end of torch 10 into opening 26 in the sleeve 24 of the mirror 20.

Similarly, dispenser 30 is mounted to the other end of the torch 10 by inserting the other end of torch 10 through opening 36 of dispenser housing 32. As can be seen from FIG. 6, the torch 10 is inserted through the opening 36 until the end of torch 10 comes into contact with rubber stopper 40.

In order to use the dental hygiene apparatus shown in FIG. 6, the dispenser 30 is moved inwardly relative to the torch 10. This pushes the rubber stopper 40 towards the outlet 42 which, in turn, reduces the volume of the chamber 38 and causes the plaque dispenser to be dispensed through outlet 42. Preferably, about 3 to 4 drops of the plaque discloser are dispensed onto the tongue of a user. The liquid in the mouth is then swished around for approximately 1 minute and any excess subsequently spat out. Due to the action of the plaque discloser, any plaque present on the teeth will be highlighted in colour.

The torch may then be turned around so that the dental mirror 22 is positioned into the mouth. The on-off switch 16 is operated to turn on the light in the torch. The illuminated dental mirror will let users identify the hard-to-see areas of the teeth particularly the inside surfaces of the teeth. A soft toothbrush and dental floss are recommended to remove the plaque.

When, after repeated use, the dispenser becomes empty of plaque discloser, it is a simple matter to remove the spent dispenser from the torch 10 and replace the spent dispenser with a fresh dispenser.

Similarly, a number of different members of a family may utilise the one torch by each member of the family having their own mirror 20 and dispenser 30. Each member of the family may assemble their mirror 20 and dispenser 30 onto the torch in order to dispense the plaque discloser into their mouth and to see where the plaque discloser is disclosing plaque. After brushing or flossing to remove the plaque discloser, their mirror and dispenser may be removed and the next member of the family may assemble their own mirror and dispenser onto the torch. The mirror and dispenser may be designed such that only the mirror and dispenser are inserted into the mouth (but not the torch). This enables hygienic use of the torch by more than one member of the family.

The dental hygiene accessory shown in FIG. 6 may be bought as a kit of parts. The kit of parts may be sold together. Alternatively, the parts may be sold separately for later assembly.

The present invention suitably uses a liquid plaque discloser. A suitable plaque discloser solution may be made from erythrosine, water, alcohol and oil of peppermint or other flavouring agent. A typical composition may be:
erythrosine—0.8 g
distilled water—100 ml
alcohol (95%)—10 ml
oil of peppermint—2 drops

It will be appreciated that other plaque discloser compositions may also be used. In particular, the other plaque discloser compositions may include paste compositions or tablet compositions. The apparatus of FIGS. 3 to 6 is also suitable for use with a paste discloser composition.

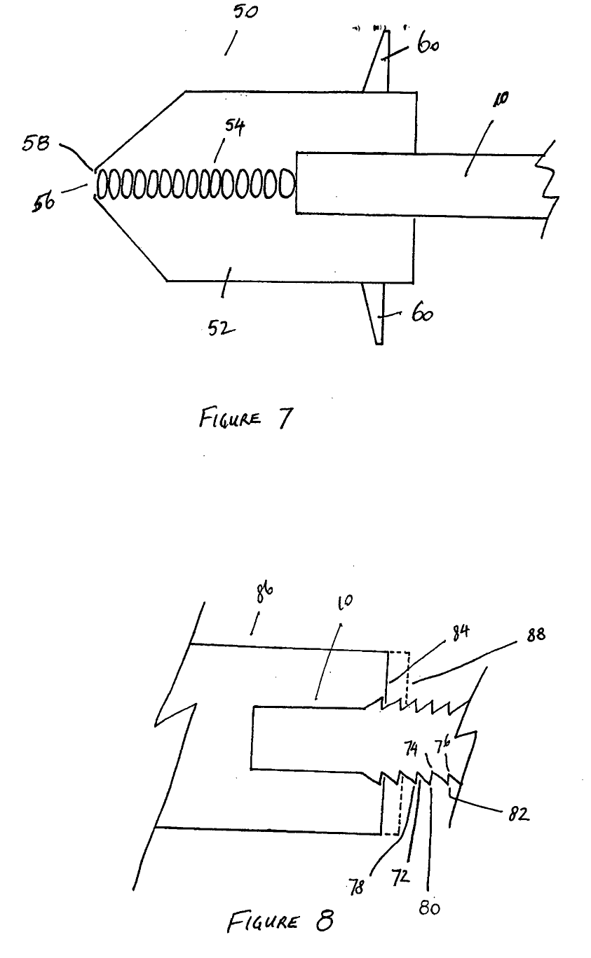

FIG. 7 shows a schematic view of a dispenser that dispenses tablets of plaque discloser. The dispenser 50 comprises a chamber 52 that holds a line of tablets 54 of plaque discloser. The chamber 52 has an outlet 56 that includes a pliable lip 58. Pliable lip 58 defines an opening that is just smaller than the outer diameter of the plaque discloser tablets. The torch 10 is mounted to the dispenser 50 in the same manner as shown in FIG. 6.

To use the dispenser of FIG. 7, the dispenser 50 is moved inwardly relative to the torch 10. The end of torch 10 thereby forces a plaque discloser tablet out of the outlet 56. The user then chews the tablet.

To facilitate dispensing of the plaque discloser, the dispenser 50 may be provided with an upstanding projection of flange 60, suitably extending around the periphery ofthe dispenser. The upstanding projection or flange allows a user to grip the accessory in a similar way to a syringe in order to facilitate dispensing of the plaque discloser.

Although not shown, the dispenser 30 in FIGS. 5 and 6 may also be provided with a similar upstanding projection or flange.

The dispenser 50 of FIG. 7 may also include a movable wall between the tablets and the end of the torch, if desired.

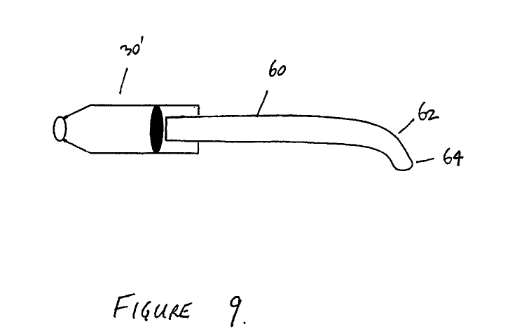

FIG. 8 shows, in expanded view, a design that allows for dispensing of a predetermined amount of plaque discloser. In FIG. 8, the outer surface of torch 10 is provided with a series of saw teeth or serrations 70 comprising troughs 72, 74, 76 separated by ridges 78, 80, 82. The end wall 84 of dispenser 86 rests in one of the troughs. When the dispenser is actuated, the end wall 86 rides up over a ridge and snaps back or nestles into the next trough, as shown in dotted outline at 88. Thus, the dispenser is moved the distance equivalent to one serration or saw tooth and thus the volume of the chamber in the dispenser is reduced by that amount.

If tablet disclosers are used, the distance of one saw tooth or serration is suitably equivalent to the thickness of one tablet.

It will be appreciated that other arrangements may be used to obtain dispensing of a pre-determined amount of discloser.

FIG. 9 shows a side view of an embodiment of another aspect of the present invention. The embodiment shown in FIG. 9 is particularly suitable for use by dentists and, for convenience, it will be described with reference to that use. However, the embodiment of FIG. 9 is capable of wider application.

The apparatus shown in FIG. 9 comprises a dispenser 30′ which is identical to the dispenser 30 shown in FIGS. 3 to 6 and need not be described further. Dispenser 30′ contains a caries detector solution. Dispenser 30′ is attached to an end of housing 60. Housing 60 has a curve 62 formed near one end 64 thereof. The housing 60 contains a source of illumination, such as a suitable light bulb, arranged to provide light to the end 64 of the housing by any known means. The light from end 64 can be used to illuminate a site or region within the mouth. The curve 62 in the housing 60 allows the site or region that is being illuminated to be easily seen by the dentist.

As a further embodiment, the housing 60 shown in FIG. 9 may also be designed such that it can replace the mirror 20 shown in FIGS. 4 and 6. Thus, the housing 60 may be arranged such that it may have an attachment sleeve for attachment to the end of a torch, such as the torch 10 shown in FIG. 3. In this embodiment, the housing 60 is effectively acting as a light pipe to direct light to the desired region within the mouth.

The light source may be a source of visible light. It could alternatively be a source of light that can act to cure dental composites used in restoration of decayed or broken teeth. For example, it may be a source of blue light, or a source of ultra-violet light.
1. Everybody in developed countries is already using or familiar with a toothbrush.
2. The use of plaque discloser forces people to brush their teeth, nobody would want to have red stains on their teeth.
3. There is no doubt the health benefits created from using the product. Absence of plaque reduces the number of fillings and incidence of gum disease.
4. The product reduces the incidence of bad breath. Dental decay and gum diseases are major factors in causing bad breath.
5. Evidence has shown that there is a link between gum disease and heart disease.
6. Consumers are more conscious of their health and appearance. Healthy teeth and gums are more sought after than ever.
7. The product provides a great opportunity in educating the public about plaque and oral hygiene.
8. The product is not a fad, which is usually determined by the unpredictable cyclical trends of fashion and timing. Toothbrushing is here to stay, regardless of fashion.
9. Everybody needs a target to achieve their goal. The target is to remove any coloured dye on their teeth. When they see that all the dye has been removed, they can feel satisfied that they have done the brushing satisfactorily. The exercise of brushing teeth becomes more predictable, that is, to remove plaque. Some people may brush their teeth rather enthusiastically, for two minutes or more, while half a minute may be adequate in their particular case. Brushing too long causes enamel erosion. But most people brush too quickly, leaving plaque behind.
10. Plaque and tartar build up causes unsightly and highly undesirable discoloured teeth.
11. Dentists can utilize the product as a diagnostic tool and as teaching purposes.
12. Dentists can use the product in the clinic to add further to their existing diagnostic tools.
13. Dentists have an alternative low cost product to cure composite, which is widely used in the clinic.

Those skilled in the art will appreciate that the present invention may be susceptible to variations and modifications other than those specifically described. It is to be understood that the present invention encompasses all such variations and modifications that fall within its spirit and scope.

1. A dental hygiene accessory comprising a housing, a mirror attached to the housing and a dispenser for dispensing a plaque discloser or a caries detector solution, the dispenser being attached to the housing.

2. A dental hygiene accessory as claimed in claim 1 wherein the dental hygiene accessory further includes a light source for illuminating the mirror.

3. A dental hygiene accessory as claimed in claim 1 wherein the mirror is removably attached to the housing.

4. A dental hygiene accessory as claimed in claim 1 wherein the dispenser is removably attached to the housing.

5. A dental hygiene accessory as claimed in claim 2 wherein the dental hygiene accessory incorporates a torch, which torch includes the housing and the light source, said light source being located at one end of the torch and the mirror being adapted to be removably attached to the torch at or near the end where the light source is located.

6. A dental hygiene accessory as claimed in claim 3 wherein the mirror includes mounting means whereby the mirror can be mounted to the housing.

7. A dental hygiene accessory as claimed in claim 6 wherein the mounting means comprises a sleeve that fits over the housing and is retained on the housing.

8. A dental hygiene accessory as claimed in claim 7 wherein the sleeve allows light transmission therethrough so that light from the light source can impinge on the mirror to thereby illuminate the mirror.

9. A dental hygiene accessory as claimed in claim 1 wherein the mirror is arranged so that it extends at an angle to a longitudinal axis of the housing.

10. A dental hygiene accessory as claimed in claim 1 wherein the dispenser includes mounting means whereby the dispenser can be mounted to the housing.

11. A dental hygiene accessory as claimed in claim 10 wherein the mounting means comprises an opening in a wall of the dispenser, said opening being arranged to receive an end of the housing such that the dispenser becomes removably attached to the housing.

12. A dental hygiene accessory as claimed in claim 1 wherein the accessory is configured such that the mirror is attached to one end of the housing and the dispenser is attached to an opposite end of the housing.

13. A dental hygiene accessory as claimed in claim 1 wherein the dispenser includes a chamber for holding the plaque discloser or the caries detector solution, the chamber having an outlet through which the plaque discloser or the caries detector solution is dispensed, and the dispenser being operable to dispense plaque discloser or caries detector solution through the outlet.

14. A dental hygiene accessory as claimed in claim 13 wherein the dispenser includes the chamber having an outlet for the plaque discloser or caries detector solution and a moveable wall, the moveable wall being moved by relative inward motion between the dispenser and the housing to thereby reduce the volume of the chamber and force plaque discloser or caries detector solution through the outlet.

15. A dental hygiene accessory as claimed in claim 14 wherein the dispenser is slideably mounted to the housing and movement of the dispenser inwardly relative to the housing causes an end of the housing to contact the moveable wall to thereby reduce the volume of the chamber and dispense plaque discloser or caries detector solution through the outlet.

16. A dental hygiene accessory as claimed in claim 1 wherein the chamber contains a liquid plaque discloser or caries detector solution and the outlet of the chamber is arranged such that the plaque discloser or caries detector solution passes therethrough when the dispenser is being used, but the plaque discloser does not leak therefrom when not in use.

17. A dental hygiene accessory as claimed claim 16 wherein the outlet includes a self-closing valve.

18. A dental hygiene accessory as claimed in claim 1 wherein the housing includes a plurality of projections at or near one end thereof, which projections cooperate with the dispenser to deliver a predetermined amount of the plaque discloser or caries detector solution.

19. A kit for assembling the dental hygiene accessory as claimed in claim 1, the kit including a torch, a mirror adapted to be removably mounted to the torch and a dispenser for dispensing a plaque discloser or caries detector solution, the dispenser including mounting means whereby the dispenser can be removably attached to the torch.

20. A dispenser for use with the dental hygiene accessory as claimed in claim 1, the dispenser including a chamber for holding a plaque discloser or caries detector solution, an outlet through which the plaque discloser or caries detector solution is dispensed, and mounting means whereby the dispenser can be removably attached to the housing.

21. A mirror for use with the dental hygiene accessory as claimed in claim 1, the mirror including mounting means whereby the mirror can be removably attached to the housing.

22. A dental accessory comprising a dispenser containing a plaque discloser or caries detector solution, the dispenser being attached to a housing, the housing having a curve at or near one end thereof and an illumination source for providing light to the one end.

23. A dental accessory comprising a housing, with a member for transmitting light, the member including a curve at or near one end thereof, the member being attached to the housing and a dispenser for dispensing a plaque discloser or a caries detector solution, the dispenser being attached to the housing.

24. A dental accessory as claimed in claim 23 wherein the member is removably attached to the housing.
